(19) United States
(12) Patent Application Publication
(10) Pub. No.: US 2023/0077508 A1
(43) Pub. Date: Mar. 16, 2023

(54) METHOD OF GENERATING INFERENCE MODEL AND INFORMATION PROCESSING APPARATUS

(71) Applicant: FUJITSU LIMITED, Kawasaki-shi (JP)

(72) Inventor: Kentaro Takemoto, Kawasaki (JP)

(73) Assignee: FUJITSU LIMITED, Kawasaki-shi (JP)

(21) Appl. No.: 17/860,810

(22) Filed: Jul. 8, 2022

(30) Foreign Application Priority Data
Sep. 16, 2021 (JP) 2021-150899

(51) Int. Cl. G06V 10/26; G06V 10/778; G06V 10/44; G06V 10/77; G06V 20/52

(52) U.S. Cl. CPC G06V 10/267; G06V 10/7796; G06V 10/457; G06V 10/7715; G06V 20/52

(57) ABSTRACT

A computer acquires training data, in which first image data, object information indicating first objects included in the first image data, and relationship information indicating a first relationship between the first objects are associated. The computer executes machine learning that trains, based on the training data, an inference model that infers both second objects included in second image data and a second relationship between the second objects or selectively infers one of the second objects and the second relationship according to an input of the second image data to the inference model. The machine learning uses a penalty term when calculating an error between an inference result of the inference model and the training data. The penalty term causes the error to increase as an overlap between inferred image regions, which are inferred to be image regions in which objects are present in the inference result, increases.

### CROSS-REFERENCE TO RELATED APPLICATION

This application is based upon and claims the benefit of priority of the prior Japanese Patent Application No. 2021-150899, filed on Sep. 16, 2021, the entire contents of which are incorporated herein by reference.

### FIELD

The embodiments discussed herein relate to a method of generating an inference model and an information processing apparatus.

### BACKGROUND

Computers use machine learning to generate an inference model that infers objects included in image data. A multi-layer neural network may be used as an inference model. An inference model may infer the presence of a plurality of objects in the same image data. As one example, an inference model may infer an object class indicating the type of object and an image region where the object is present for each of a plurality of objects included in image data.

A proposed navigation system uses vehicle-mounted cameras to acquire a plurality of image data captured in the periphery of a vehicle, detects other vehicles and their wheels from the image data, and recognizes how the wheels of the other vehicles are moving. A simulation system that uses deep learning to improve the accuracy of image recognition, which detects obstacles from image data produced by a vehicle-mounted camera, has also been proposed. There has also been proposed an object detection apparatus that infers the density of objects from image data including a plurality of objects that are the same type, changes the partial shape to be focused on out of the shape of the objects based on the density, and determines the respective positions of the plurality of objects.

See, for example, International Publication Pamphlet No. WO2018/005441, Japanese Laid-open Patent Publication No. 2018-60511, and Japanese Laid-open Patent Publication No. 2018-165966.

Another example of a task that extracts information from image data is relationship inference where relationships are inferred between a plurality of objects included in image data. As examples, the relationships between objects may include a relationship where a person is standing on a given object and/or a relationship where an animal is chasing another animal.

Note here that instead of executing object inference and relationship inference using separate inference models, it may be possible to improve the accuracy of the extracted information with an integrated configuration where both types of inference are executed by a single inference model. As one example, feature values calculated during object inference may be useful in improving the accuracy of relationship inference. Similarly, feature values calculated during relationship inference may be useful in improving the accuracy of object inference.

However, during object inference, an inference model may extract various image region candidates, which are regions that potentially include an object, from the image data. This means that when an inference model capable of executing both object inference and relationship inference is generated without regard to this, there is the risk of a relationship being inferred between a plurality of image region candidates that include what is effectively the same object. This would cause a drop in the accuracy of the information extracted from the image data.

### SUMMARY

According to an aspect, there is provided a non-transitory computer-readable recording medium storing therein a computer program that causes a computer to execute a process including: acquiring training data in which first image data, object information indicating a plurality of first objects included in the first image data, and relationship information indicating a first relationship between the plurality of first objects are associated; and executing machine learning that trains, based on the training data, an inference model that infers both a plurality of second objects included in second image data and a second relationship between the plurality of second objects or selectively infers one of the plurality of second objects and the second relationship according to an input of the second image data to the inference model, the machine learning using a penalty term when calculating an error between an inference result of the inference model and the training data, the penalty term causing the error to increase as an overlap between a plurality of inferred image regions, which are inferred to be image regions in which objects are present in the inference result, increases.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts an information processing apparatus according to a first embodiment;

FIG. 2 is a block diagram depicting example hardware of the information processing apparatus;

FIG. 3 depicts an example scene graph generated by image recognition;

FIG. 4 depicts a first example use of a scene graph;

FIG. 5 depicts a second example use of a scene graph;

FIG. 6 depicts an example of an image for which object detection accuracy is low;

FIG. 7 depicts an example structure of training data;

FIG. 8 depicts an example structure of a model that detects objects and relationships;

FIG. 9 depicts an example calculation of an error between inference data and correct answer data;

FIG. 10 depicts example relationships between detected regions and a penalty;

FIG. 11 is a block diagram depicting example functions of the information processing apparatus;

FIG. 12 is a flowchart depicting an example procedure of model generation; and

FIG. 13 is a flowchart depicting an example procedure of image recognition.

### DESCRIPTION OF EMBODIMENTS

Several embodiments will be described below with reference to the accompanying drawings.

### First Embodiment

A first embodiment will now be described.

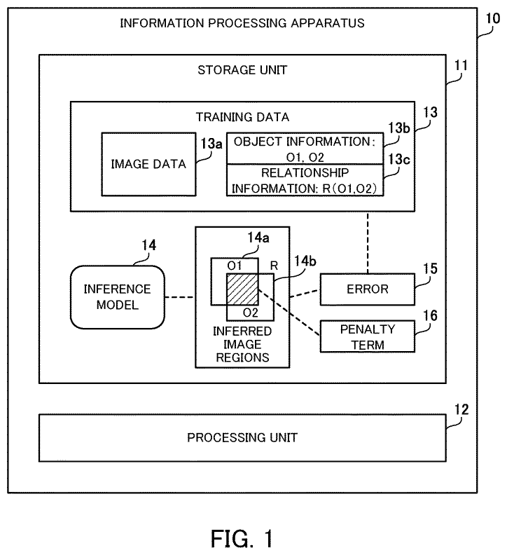

FIG. 1 depicts an information processing apparatus according to the first embodiment.

An information processing apparatus 10 according to the first embodiment generates an inference model through machine learning. The inference model performs image recognition that extracts information from image data. The information processing apparatus 10 may be a client apparatus or may be a server apparatus. The information processing apparatus 10 may be referred to as a “computer”, an “inference model generating apparatus”, or a “machine learning apparatus”.

The information processing apparatus 10 includes a storage unit 11 and a processing unit 12. The storage unit 11 may be volatile semiconductor memory, such as random access memory (RAM), or nonvolatile storage such as a hard disk drive (HDD) or flash memory. The processing unit 12 is a processor, such as a central processing unit (CPU), a graphics processing unit (GPU), or a digital signal processor (DSP). The processing unit 12 may include special-purpose electronic circuitry, such as an application-specific integrated circuit (ASIC) or a field programmable gate array (FPGA). As one example, the processor executes a program stored in a memory such as RAM (which may be the storage unit 11). A group of processors used here may be referred to as a “multiprocessor” or simply as a “processor”.

The storage unit 11 stores training data 13. The processing unit 12 may generate the training data 13 from annotated image data. The training data 13 includes image data 13a, object information 13b, and relationship information 13c that have been associated with each other. The training data 13 may include a plurality of sets of image data, object information, and relationship information. As one example, the image data 13a is monochrome image data or color image data with a specified number of pixels (or “height”) in the vertical direction and a specified number of pixels (or “width”) in the horizontal direction. The image data 13a includes a plurality of objects, such as objects O1 and O2. The training data 13 corresponds to “input data”.

The object information 13b indicates a plurality of objects included in the image data 13a. As one example, the object information 13b includes object classes indicating the respective types of the objects O1 and O2. Potential values or “candidates” for the object class are decided in advance. Objects may be people, may be animals aside from people, such as dogs and cats, or may be inanimate objects, such as skis or a fire hydrant. The object information 13b may include position information indicating image regions in the image data 13a where each object in the plurality of objects is present.

The relationship information 13c indicates relationships between the plurality of objects. As one example, the relationship information 13c includes a relationship class indicating the type of a relationship R established between the objects O1 and O2. Potential values or “candidates” for the relationship classes are decided in advance. Example relationships include “is standing on” and “is chasing”. The relationship information 13c may include position information indicating the image regions in which the plurality of objects in a relationship are respectively present. The object information 13b and the relationship information 13c correspond to “teacher data”.

The processing unit 12 performs machine learning that generates an inference model 14 based on the training data 13. The inference model 14 infers, from the image data, both a plurality of objects included in the image data and relationships between the plurality of objects. Alternatively, the inference model 14 selectively infers one of the plurality of objects and relationships in keeping with an input. Control information for selecting whether to infer objects and/or to infer relationships may be inputted into the inference model 14. As one example, the inference model 14 is a multilayer neural network that includes edge weights as parameters.

During machine learning, the processing unit 12 calculates an error 15 between an inference result of the inference model 14 and the training data 13, feeds back the error 15, and optimizes the parameters included in the inference model 14 so as to reduce the error 15. As one example, the processing unit 12 inputs the image data 13a into the inference model 14 and compares the output of the inference model 14 with at least one of the object information 13b and the relationship information 13c to calculate the error 15. The processing unit 12 may update the parameters according to backpropagation. As one example, the processing unit 12 propagates error information from the back to the front of the inference model 14, calculates a gradient of the error 15 relative to the parameters, and changes the parameters by an amount in keeping with the gradient.

Here, the processing unit 12 uses a penalty term 16 to calculate the error 15. The penalty term 16 is configured so that the error 15 increases in keeping with an extent of overlap between a plurality of inferred image regions that have been inferred as image regions in which objects are present in the inference result of the inference model 14. As one example, when the image data 13a has been inputted into the inference model 14, an inferred image region 14a corresponding to the object O1 and an inferred image region 14b corresponding to the object O2 are inferred by the inference model 14. The penalty term 16 adds a penalty set in keeping with the extent of overlap between the inferred image regions 14a and 14b to the error 15.

The extent of overlap between the inferred image regions 14a and 14b may be intersection over union (IoU). The IoU is the ratio of the area of a logical product (that is, a common part) of the inferred image regions 14a and 14b to an area of a logical sum of the inferred image regions 14a and 14b. The processing unit 12 may increase the error 15 in keeping with an increase in the IoU, and may set the penalty proportionally to the IoU. However, the processing unit 12 may regard the penalty as zero when the IoU is below a threshold. Note that it is possible to apply the penalty term 16 to only an error in the inference result for the relationship R. Accordingly, the plurality of inferred image regions described above may correspond to a plurality of objects that have been inferred to be in a relationship.

Note that the processing unit 12 may display the inference model 14 generated through machine learning on a display apparatus, may store the inference model 14 in nonvolatile storage, and/or may transmit the inference model 14 to another information processing apparatus. The information processing apparatus 10 may also extract object information and/or relationship information from the image data using the inference model 14. It is also possible for another information processing apparatus to use the inference model 14.

As described above, the information processing apparatus 10 according to the first embodiment performs machine learning that generates the inference model 14 based on the training data 13. From image data, the inference model 14 infers both a plurality of objects included in the image data and relationships between the objects or selectively infers one of the plurality of objects and the relationships between the objects according to an input. The information processing apparatus 10 uses the penalty term 16 to calculate the error 15 between the inference result of the inference model 14 and the training data 13. The penalty term 16 is set so that the error 15 increases in keeping with the extent of overlap between the plurality of inferred image regions that have been inferred as image regions in which objects are present.

By doing so, the inference model 14 is capable of inferring a plurality of objects included in image data, inferring relationships between the plurality of objects included in the image data, and extracting useful information from the image data. The inference model 14 is capable of performing object inference and relationship inference in an integrated manner, which improves the accuracy of the extracted information. As one example, the inference model 14 makes interactive use of feature values calculated during object inference and feature values calculated during relationship inference, which improves the accuracy of object inference and the accuracy of relationship inference.

When an inference model in which object inference and relationship inference are simply combined is generated, since various image region candidates would be extracted from the image data during object inference, there is the risk of the inference model inferring relationships between a plurality of image region candidates that represent effectively the same objects. On the other hand, using the penalty term 16 to calculate the error 15 reduces the risk of inferring inappropriate relationships, which improves the accuracy of the extracted information.

Note that the inference model 14 may include a first block that calculates feature values of the image data, a second block that infers objects using the feature values, and a third block that infers relationships using the feature values. As a result, interactive use is made of feature values that are useful for object inference and feature values that are useful for relationship inference, which improves the accuracy of object inference and the accuracy of relationship inference.

The first block may calculate the feature values from type selection information, which indicates whether to perform inference of objects and/or whether to perform inference of relationships, and the image data. When performing inference of objects, the feature values may be inputted into the second block, and when performing inference of relationships, the feature values may be inputted into the third block. By doing so, the inference model 14 is capable of outputting inference results in different data formats for object inference and relationship inference (as one example, inference results of different data sizes).

The inference model 14 may output a plurality of inference boxes. An inference box may selectively include one of an inference result for objects and an inference result for relationships based on the type selection information inputted into the inference model 14. This makes it possible for the user to flexibly adjust the number of objects and the number of relationships to be inferred in keeping with the image data.

The inference model 14 may infer image regions in which objects are present in the image data, object classes indicating the respective types of the objects, and relationship classes indicating the types of relationships between the objects. By doing so, useful information expressing the features of the image data is extracted. As examples, information that is useful for implementing image searches that search for desired image data using natural language and/or implementing a question answering system that provides appropriate answers to questions relating to objects included in image data is extracted.

### Second Embodiment

A second embodiment will now be described.

An information processing apparatus 100 according to the second embodiment generates an inference model for use in image recognition through machine learning. A multilayer neural network is used as the inference model. The information processing apparatus 100 performs image recognition using the generated inference model. However, model generation and image recognition may be performed by difference information processing apparatuses. The information processing apparatus 100 corresponds to the information processing apparatus 10 in the first embodiment. The information processing apparatus 100 may be a client apparatus or may be a server apparatus. The information processing apparatus 100 may be referred to as a “computer”, a “machine learning apparatus”, or an “image recognition apparatus”.

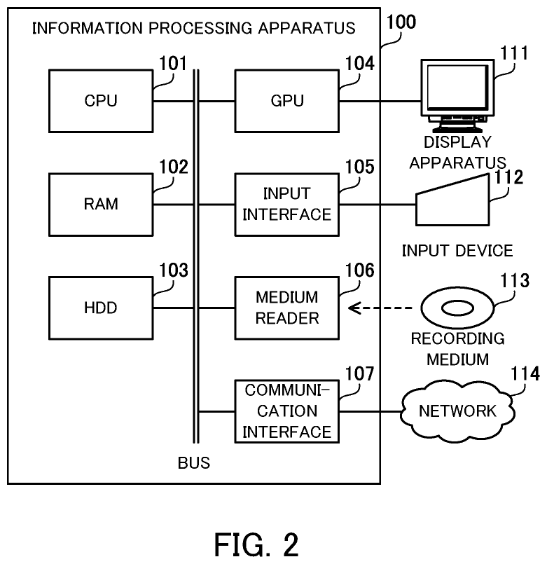

FIG. 2 is a block diagram depicting example hardware of an information processing apparatus.

The information processing apparatus 100 includes a CPU 101, RAM 102, an HDD 103, a GPU 104, an input interface 105, a medium reader 106, and a communication interface 107 that are connected to a bus. The CPU 101 corresponds to the processing unit 12 in the first embodiment. The RAM 102 or the HDD 103 corresponds to the storage unit 11 in the first embodiment.

The CPU 101 is a processor that executes instructions of a program. The CPU 101 loads at least part of a program and data stored in the HDD 103 into the RAM 102 and executes the program. The information processing apparatus 100 may include a plurality of processors. A group of processors used here may be referred to as a “multiprocessor” or simply as a “processor”.

The RAM 102 is volatile semiconductor memory that temporarily stores a program to be executed by the CPU 101 and data to be used in computation by the CPU 101. The information processing apparatus 100 may include a type of volatile memory aside from RAM.

The HDD 103 is nonvolatile storage that stores data and software programs such as an operating system (OS), middleware, and application software. The information processing apparatus 100 may include nonvolatile storage of a different type, such as flash memory and/or a solid state drive (SSD).

The GPU 104 operates in concert with the CPU 101 to generate images and outputs the images to a display apparatus 111 connected to the information processing apparatus 100. As examples, the display apparatus 111 is a cathode ray tube (CRT) display, a liquid crystal display, an organic electroluminescence (EL) display, or a projector. Note that the information processing apparatus 100 may be connected to other types of output device, such as a printer.

The input interface 105 receives an input signal from an input device 112 connected to the information processing apparatus 100. As examples, the input device 112 may be a mouse, a touch panel, or a keyboard. A plurality of input devices may be connected to the information processing apparatus 100.

The medium reader 106 is a reader apparatus that reads a program and data recorded on a recording medium 113. As examples, the recording medium 113 is a magnetic disk, an optical disc, or a semiconductor memory. Examples of magnetic disks include flexible disks (FD) and HDD. Examples of optical discs include compact discs (CD) and digital versatile discs (DVD). The medium reader 106 copies programs and data that have been read out from the recording medium 113 into another recording medium, such as the RAM 102 or the HDD 103. A program that is read out may be executed by the CPU 101.

The recording medium 113 may be a portable recording medium. The recording medium 113 may be used to distribute a program and data. The recording medium 113 and the HDD 103 may be referred to as “computer-readable recording media”.

The communication interface 107 is connected to a network 114 and communicates with other information processing apparatuses via the network 114. The communication interface 107 may be a wired communication interface that is connected to a wired communication apparatus such as a switch or a router, or may be a wireless communication interface connected to a wireless communication apparatus such as a base station or an access point.

Next, generation of a scene graph and an application that uses a scene graph will be described. The inference model generated by the information processing apparatus 100 determines, from the image data, boundary boxes indicating regions in which the respective objects out of the plurality of objects appear, object classes indicating the respective types of the plurality of objects, and relationship classes indicating the types of relationships established between the plurality of objects. The information processing apparatus 100 generates a scene graph in which two or more nodes indicating object classes and one or more nodes indicating relationship classes are linked. The information processing apparatus 100 uses the scene graph to implement application software, such as image searching.

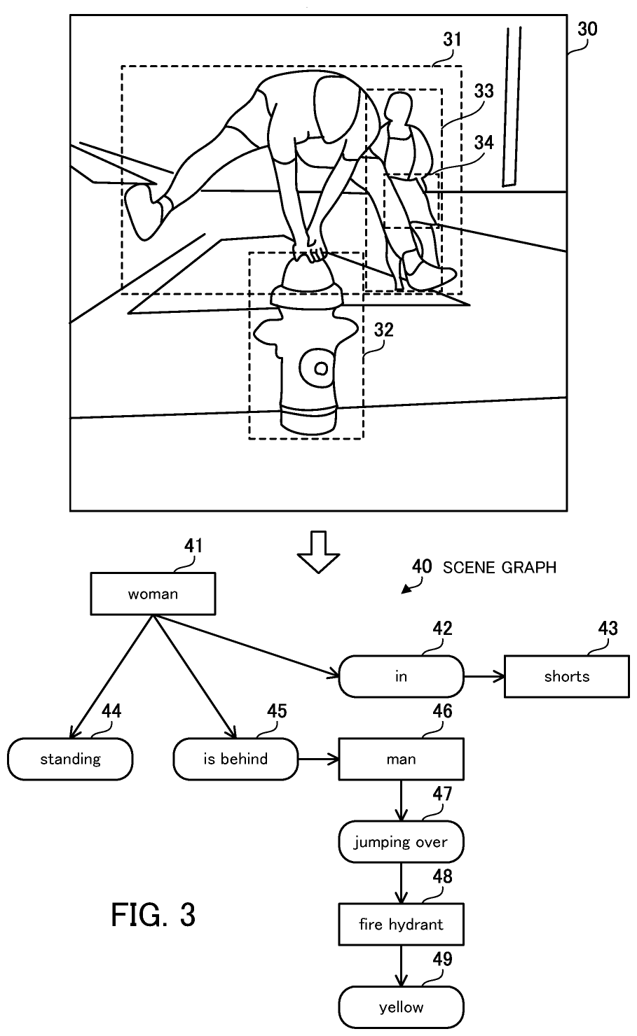

FIG. 3 depicts an example scene graph generated by image recognition.

Image data 30 is data composed of a height that is the number of pixels in the vertical direction, a width that is the number of pixels in the horizontal direction, and three channels representing the colors red, green, and blue (RGB). The inference model detects rectangular regions 31 to 34 from the image data 30.

The inference model detects that the region 31 represents a man, the region 32 represents a fire hydrant, the region 33 represents a woman, and the region 34 represents a pair of shorts. The inference model also detects a relationship whereby the man in the region 31 is jumping over the fire hydrant in the region 32, a relationship whereby the woman in the region 33 is behind the man in the region 31, and a relationship whereby the woman in the region 33 is wearing the shorts in the region 34. The inference model detects that the fire hydrant in the region 32 is yellow and that the woman in the region 33 is standing.

The information processing apparatus 100 generates a scene graph 40 from the result of the image recognition described above. The scene graph 40 is a directed graph and includes the nodes 41 to 49. The node 41 represents the object in the region 33. The node 42 represents a relationship of being worn on the body. The node 43 represents the object in the region 34. The node 44 represents an attribute of standing. The node 45 represents a relationship of being behind something or someone. The node 46 represents the object in the region 31. The node 47 represents a relationship of jumping over something. The node 48 represents the object in the region 32. The node 49 represents the attribute of being yellow.

The scene graph 40 includes edges from the node 41 to the nodes 42, 44, and 45 and an edge from the node 42 to the node 43. The scene graph 40 also includes an edge from the node 45 to the node 46, an edge from the node 46 to the node 47, an edge from the node 47 to the node 48, and an edge from the node 48 to the node 49. The scene graph 40 expresses that the woman is wearing the shorts, the woman is standing, the woman is behind the man, the man is jumping over the fire hydrant, and the fire hydrant is yellow.

Note that scene graphs are described in the following non-patent literature, Kaihua Tang, Yulei Niu, Jianqiang Huang, Jiaxin Shi and Hanwang Zhang, “Unbiased Scene Graph Generation from Biased Training”, Proc. of the 2020 IEEE/CVF Conference on Computer Vision and Pattern Recognition (CVPR 2020), pp. 3716-3725, June 2020.

Visual question answering (VQA), image searching, and caption generation are examples of applications that use scene graphs. In VQA, a question relating to the state of objects appearing in an image is received and an appropriate answer is provided based on the image. Image searching searches a plurality of images for images that match a search phrase expressed in natural language. Caption generation generates a caption that describes features of an image in natural language.

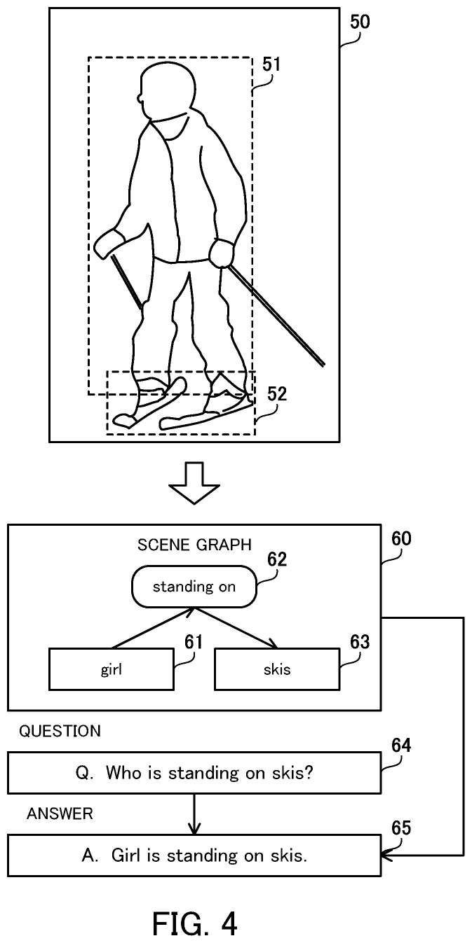

FIG. 4 depicts a first example use of a scene graph.

VQA will now be described. The inference model detects regions 51 and 52 from image data 50. The inference model detects that the region 51 represents a girl and the region 52 represents some skis. The inference model detects a relationship whereby the girl in the region 51 is standing on the skis in the region 52. The information processing apparatus 100 generates a scene graph 60 from the result of the image recognition described above. The scene graph includes nodes 61 to 63.

The node 61 represents the object in the region 51. The node 62 represents a relationship of standing on something. The node 63 represents the object in the region 52. The scene graph 60 includes an edge from the node 61 to the node 62 and an edge from the node 62 to the node 63. The scene graph 60 expresses that the girl is standing on the skis.

A VQA system receives a question 64 from a user. The question 64 is the phrase “who is standing on skis?” The VQA system extracts the verb phrase “standing on” and the object “skis” from the question 64 through natural language processing. The VQA system searches the scene graph 60 for the subject “girl” which is connected to the verb phrase and object. The VQA system then outputs an answer 65. The answer 65 is composed of the phrase “Girl is standing on skis”. In this way, the VQA system generates the answer 65 for the question 64 using the scene graph 60.

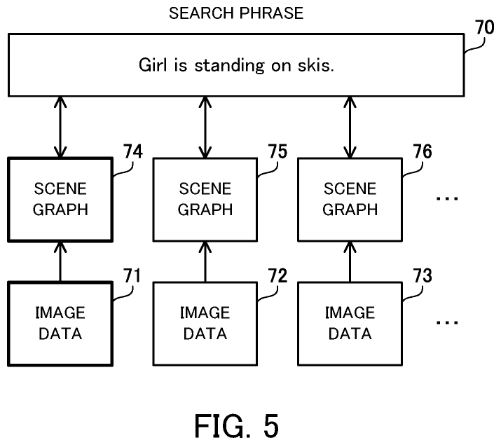

FIG. 5 depicts a second example use of a scene graph.

Image searching will now be described. The inference model generates scene graphs 74, 75, 76, . . . from image data 71, 72, 73, . . . . An image searching system receives a search phrase 70 from the user. The search phrase 70 is composed of a phrase “Girl is standing on skis”. The image searching system extracts the subject “girl”, the verb phrase “is standing on” and the object “skis” from the search phrase 70 through natural language processing.

The image searching system searches the scene graphs 74, 75, 76, . . . and finds the scene graph 74 where the subject, the verb phrase, and the object indicated above are connected. The image searching system outputs the image data 71 corresponding to the scene graph 74 found by the search as the search result for the search phrase 70. In this way, the image searching system uses the scene graphs 74, 75, 76, . . . to generate a search result for the search phrase 70.

Next, relationship detection that detects relationships between a plurality of objects from image data will be described. Relationship detection is implemented by a method split into an object inference model that performs an object detection task and a relationship inference model that performs a relationship detection task, with the output of the object inference model being inputted into the relationship inference model. The object inference model infers an object class and a region for each of a plurality of objects from image data. The relationship inference model extracts the regions inferred by the object inference model from the image data and infers relationship classes indicating the relationships established between the plurality of regions from the object classes inferred by the object inference model and feature values of the regions.

However, when relationship detection is implemented as described above, since the input into the relationship inference model is the inference result of the object inference model, the inference accuracy of the relationship inference model is affected by the inference accuracy of the object inference model. Accordingly, when the object detection accuracy is low, meaning that an inferred object class or an inferred region is incorrect, the relationship detection accuracy will also be low. Also, since the relationship detection task is executed after the object detection task, the object detection task does not make use of information produced by the relationship detection task.

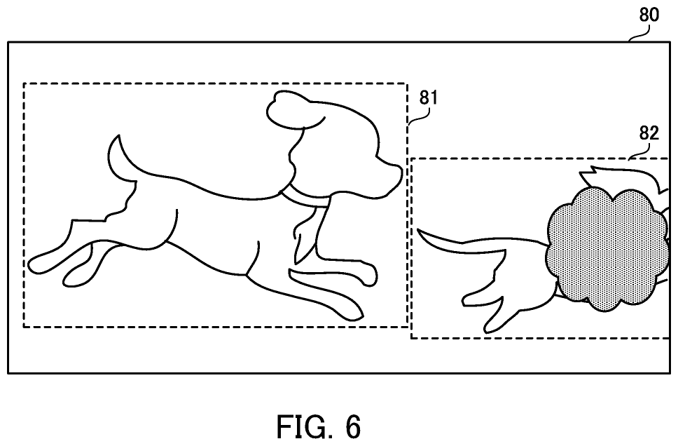

FIG. 6 depicts an example of an image for which object detection accuracy is low.

Image data 80 represents a scene where a dog is chasing a cat. The image data 80 includes a region 81 representing the dog and a region 82 representing the cat. However, in the region 82, around half of the cat's shape is hidden by an obstacle. Since the object inference model infers that the object class for each of the plurality of objects separately, although it will be easy to correctly infer that the object class of the region 81 is “dog”, it will be difficult to correctly infer that the object class of the region 82 is “cat”.

On the other hand, from the object class of the region 81, feature values of the region 81, and the positional relationship between the regions 81 and 82, it is possible for the relationship inference model to calculate a high probability of a relationship whereby the dog is chasing something. When information indicating that the object in the region 82 is being chased by the dog is available, it becomes easier for the object inference model to correctly infer from feature values of the region 82 (as one example, the shape of the non-hidden part) that the object class of the region 82 is “cat”.

In this way, by cross referencing information obtained during the object detection task and information obtained during the relationship detection task, it may be possible to improve both the object detection accuracy and the relationship detection accuracy. For this reason, the inference model according to the second embodiment does not perform the object detection task and the relationship detection task separately and instead executes the tasks in an integrated manner.

Next, machine learning that generates the inference model according to the second embodiment will be described.

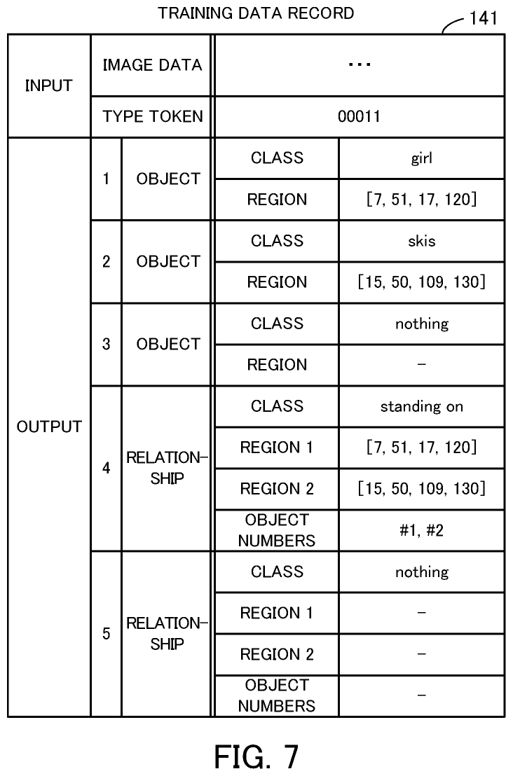

FIG. 7 depicts an example structure of training data.

The training data used in machine learning that generates an inference model includes a plurality of training data records, such as a training data record 141. The training data record 141 includes input data and output data. The output data corresponds to teacher data.

The input data includes image data and a type token. The image data is normalized to a size composed of a height H₀ by a width W₀ by three color channels. The type token is a flag that switches between object detection and relationship detection. As described later, the output of the inference model according to the second embodiment includes a fixed number of inference boxes. Each inference box indicates one of an object detection result and a relationship detection result. The type token designates the type of each inference box.

To simplify the description, an example case will be used where the inference model outputs five inference boxes. As one example, the type token is “00011”, where “0” indicates object detection and “1” indicates relationship detection. Accordingly, this type token indicates that the inference boxes #1, #2, and #3 are object inference boxes, and inference boxes #4 and #5 are relationship inference boxes. In this way, the ratio between the number of objects to be detected and the number of relationships to be detected is variable. It is preferable for the training data to include training data records with different type tokens.

The output data includes correct answer data for each of the plurality of inference boxes. The correct answer data of an object inference box includes an object class and the coordinates of a region. The object classes include the term “nothing” to indicate when no object is detected. The region is expressed by four numeric values composed of an x-coordinate of an upper left point, an x-coordinate of a lower right point, a y-coordinate of the upper left point, and a y-coordinate of the lower right point.

The object class is expressed by a vector with a fixed number of dimensions. Each dimension in the vector corresponds to one object class candidate. The inference model outputs a vector in which respective probabilities of a plurality of object class candidates are listed. The sum of the probabilities of the plurality of object class candidates is 1. On the other hand, a vector where the dimension of the correct object class is 1 and the other dimensions are 0 is used as the correct answer data. The correct answer data of an object inference box has (number of object classes+4) dimensions.

The correct answer data for a relationship inference box includes a relationship class, coordinates of two regions, and the object numbers of two objects. The relationship classes include the term “nothing” to indicate when no relationship is detected. The two regions correspond to the two objects in a relationship. The first region represents an object corresponding to a grammatical subject, and the second region represents an object corresponding to a grammatical object. Each of the two regions is expressed by four numeric values: the x-coordinate of an upper left point, the x-coordinate of a lower right point, the y-coordinate of the upper left point, and the y-coordinate of the lower right point. An object number is the number of an object inference box indicating an object in the relationship. The first object number represents the object corresponding to the grammatical subject and corresponds to region 1. The second object number represents the object corresponding to a grammatical object and corresponds to region 2.

The relationship class is expressed by a vector with a fixed number of dimensions. Each dimension in the vector corresponds to one relationship class candidate. The inference model outputs a vector in which respective probabilities of a plurality of relationship class candidates are listed. The sum of the probabilities of the plurality of relationship class candidates is 1. On the other hand, a vector where the dimension of the correct relationship class is 1 and the other dimensions are 0 is used as the correct answer data. The correct answer data of a relationship inference box has (number of object classes +10) dimensions.

The training data record 141 is one example of a training data record generated from the image data 50 in FIG. 4. The correct answer data for inference box #1 indicates that the object class is “girl” and the region is (7, 51, 17, 120). The correct answer data for inference box #2 indicates that the object class is “skis” and the region is (15, 50, 109, 130). The correct answer data for inference box #3 indicates that the object class is “nothing”. The correct answer data for inference box #4 indicates that the relationship class is “standing on”, region 1 is (7, 51, 17, 120), region 2 is (15, 50, 109, 130), and the object numbers are #1 and #2. The correct answer data for inference box #5 indicates that the relationship class is “nothing”.

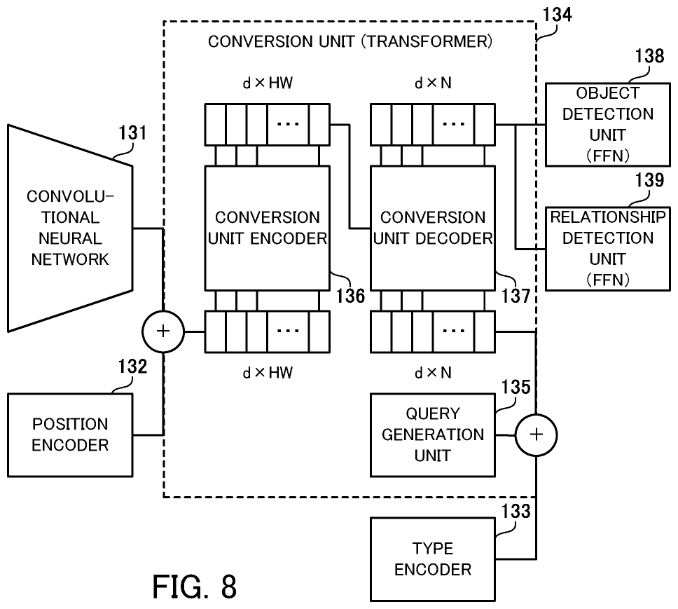

FIG. 8 depicts an example structure of a model that detects objects and relationships.

The inference model according to the second embodiment includes a convolutional neural network (CNN) 131, a position encoder 132, a type encoder 133, a conversion unit 134, an object detection unit 138, and a relationship detection unit 139. The conversion unit 134 includes a query generation unit 135, a conversion unit encoder 136, and a conversion unit decoder 137.

The convolutional neural network 131 is a multilayer neural network including a convolutional layer. The convolutional neural network 131 receives color image data that is the height H₀ by the width W₀ with three color channels. The convolutional neural network 131 outputs a feature map of a height H by a width W with d channels produced by a convolution operation. As example values, H=H₀/32, W=W₀/32, and d=256.

The convolution operation is a product-sum operation in which a coefficient matrix called a “kernel” is superimposed on the image data and the products of pixel values and the coefficients at corresponding positions are summed. The convolution operation repeats the product-sum operation while shifting the kernel over the image data to generate a feature map that is the same size as the image data or is smaller than the image data. The convolutional neural network 131 uses different kernels to generate feature maps of a plurality of channels from the same image data. The coefficients included in a kernel correspond to the weights of edges between nodes in a neural network. These edge weights are parameters that are to be optimized through machine learning.

The position encoder 132 encodes the position coordinates of each of the H×W pixels included in the feature map outputted by the convolutional neural network 131. The position encoder 132 calculates a d-dimensional position vector from the position coordinates of the respective pixels. Accordingly, the position encoder 132 outputs H×W d-dimensional position vectors. Here, it is preferable for position vectors that are similar to be calculated from position coordinates that are close to each other. The position encoder 132 calculates a position vector using a sine function (sin) or a cosine function (cos), for example. The position vectors are fixed values that do not change due to machine learning.

The type encoder 133 encodes an inputted type token. The type encoder 133 calculates a d-dimensional type vector, from flags that are 0 or 1, for each of N inference boxes. Accordingly, the type encoder 133 outputs N d-dimensional type vectors. As one example, N=100. The type vectors corresponding to “0” and the type vectors corresponding to “1” may be fixed values that do not change due to machine learning.

The conversion unit 134 calculates feature values for each of the N inference boxes from the feature map outputted by the convolutional neural network 131, the position vectors outputted by the position encoder 132, and the type vectors outputted by the type encoder 133. The conversion unit 134 may be referred to as a “transformer”.

The conversion unit 134 deforms the feature map of the height H, the width W, and d channels outputted by the convolutional neural network 131 to form H×W d-dimensional feature values. For the respective H×W feature values, the conversion unit 134 arithmetically adds the corresponding position vector out of the H×W d-dimensional position vectors outputted by the position encoder 132. By doing so, the conversion unit 134 calculates H×W d-dimensional feature values f.

The query generation unit 135 outputs a d-dimensional query vector for each of the N inference boxes.

A query vector is a parameter that has been optimized through machine learning. For each of the N inference boxes, the conversion unit 134 arithmetically adds the d-dimensional type vector outputted by the type encoder 133 to the d-dimensional query vector outputted by the query generation unit 135. By doing so, the conversion unit 134 calculates N d-dimensional queries q.

The conversion unit encoder 136 is a neural network that converts the H×W d-dimensional feature values f into H×W d-dimensional feature values g. The edge weights included in the neural network are parameters that are to be optimized through machine learning. The conversion unit encoder 136 processes the H×W feature values f in parallel without including feedback paths. However, the H×W feature values f influence each other. That is, a given feature value g is calculated based on all of the H×W feature values f.

As one example, the conversion unit encoder 136 has a structure in which six layer groups with the same structure are connected in series. Each layer group includes an attention mechanism network and a feed forward network (FFN). The attention mechanism network searches for all of the other pixels to be placed in attention when calculating the feature value g of a given pixel based on correlation of the feature values f between the H×W pixels, and calculates attention probabilities.

The conversion unit decoder 137 is a neural network that uses the H×W d-dimensional feature values g outputted by the conversion unit encoder 136 to convert the N d-dimensional queries q to N d-dimensional feature values h. The edge weights included in the neural network are parameters that are to be optimized through machine learning. The conversion unit decoder 137 processes N queries q in parallel without including feedback paths.

As one example, the conversion unit decoder 137 has a structure in which six layer groups with the same structure are connected in series. Each layer group includes an attention mechanism network and a feed forward network. However, when performing computation, each layer group uses the H×W feature values g received from the conversion unit encoder 136 in addition to the query q or the output of the layer group on a previous stage. As one example, each layer group includes one more attention mechanism network than the conversion unit encoder 136.

The N feature values h outputted by the conversion unit decoder 137 correspond to the N inference boxes. Each of the N feature values h is inputted into either the object detection unit 138 or the relationship detection unit 139 according to the type token. The feature value h of an object inference box is inputted into the object detection unit 138, and the feature value h of the relationship inference box is inputted into the relationship detection unit 139. However, the inference model may be configured to input all N feature values h into both the object detection unit 138 and the relationship detection unit 139, with each type of inference data being selectively used according to the type token.

The object detection unit 138 processes each object inference box individually. The object detection unit 138 is a neural network that generates (number of object classes+4)-dimensional inference data from d-dimensional feature values h. This neural network is a feed forward network that does not include a feedback path. The edge weights included in this neural network are parameters that are to be optimized through machine learning.

The relationship detection unit 139 processes each relationship inference box individually. The relationship detection unit 139 is a neural network that generates (number of object classes+10)-dimensional inference data from the d-dimensional feature values h. This neural network is a feed forward network that does not include a feedback path. The edge weights included in the neural network are parameters that are to be optimized through machine learning.

Note that transformers are described in the following non-patent literature. Nicolas Carion, Francisco Massa, Gabriel Synnaeve, Nicolas Usunier, Alexander Kirillov and Sergey Zagoruyko, “End-to-End Object Detection with Transformers”, Proc. of the 16th European Conference on Computer Vision (ECCV 2020), pp. 213-229, August 2020.

The information processing apparatus 100 uses the training data to optimize the parameters included in the inference model. As one example, error backpropagation is used for this optimization. The information processing apparatus 100 selects a training data record from the training data, inputs the image data included in the input data into the convolutional neural network 131, and inputs the type token included in the input data into the type encoder 133. The information processing apparatus 100 calculates an object detection error by comparing the inference data for the object inference boxes outputted by the object detection unit 138 with the correct answer data. The information processing apparatus 100 also calculates a relationship detection error by comparing the inference data for the relationship inference boxes outputted by the relationship detection unit 139 with the correct answer data.

The information processing apparatus 100 calculates the overall error that is the sum of the object detection error and the relationship detection error and updates parameters by feeding back the overall error. As one example, the information processing apparatus 100 back propagates error information from the back of the neural network toward the front. The information processing apparatus 100 calculates the gradient between the error and the parameters, and updates the parameters from the error gradient and a learning rate, which is a hyperparameter, so that the error becomes smaller.

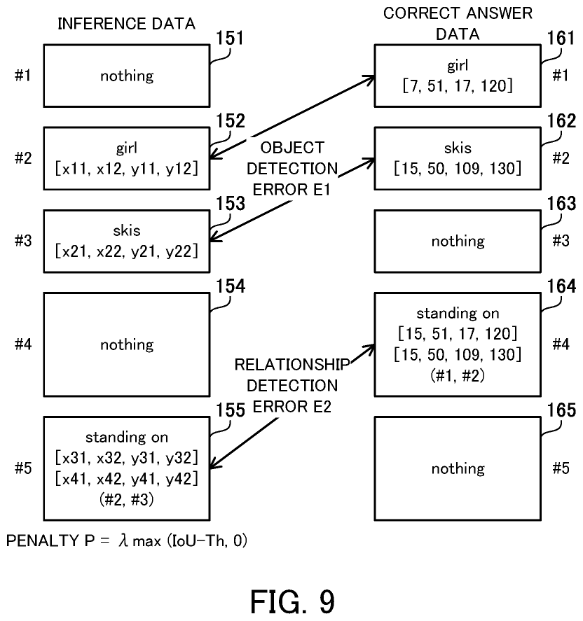

FIG. 9 depicts an example calculation of an error between the inference data and the correct answer data.

Even when the object class and the relationship class that have been inferred by the inference model are the same as the object class and the relationship class specified in the training data record for N inference boxes, the classes may be arranged in a different order. For this reason, the information processing apparatus 100 calculates the overall error by searching for pairs of inference data and correct answer data that minimize the error.

Here, for ease of explanation, a case where there are five inference boxes will be described. The inference data 151 to 155 correspond to inference boxes #1 to #5. The correct answer data 161 to 165 also correspond to the inference boxes #1 to #5. The inference data 151 indicates that the object class is “nothing”. The inference data 152 indicates that the object class is “girl” and the region is (x11, x12, y11, y12). The inference data 153 indicates that the object class is “skis” and the region is (x21, x22, y21, y22). The inference data 154 indicates that the relationship class is “nothing”. The inference data 155 indicates that the relationship class is “standing on”, the region 1 is (x31, x32, y31, y32), the region 2 is (x41, x42, y41, y42), and the object numbers are #2 and #3.

For the object inference boxes, the inference data that is closest to the correct answer data 161 is the inference data 152. The inference data that is closest to the correct answer data 162 is the inference data 153. For this reason, the information processing apparatus 100 calculates the object detection error E1 based on the difference between the inference data 152 and the correct answer data 161 and the difference between the inference data 153 and the correct answer data 162. As one example, the information processing apparatus 100 calculates the distance for a pair of (number of object classes+4)-dimensional vectors for each object inference box and sums the distances for the plurality of object inference boxes.

For the relationship inference boxes, the inference data that is closest to the correct answer data 164 is the inference data 155. For this reason, the information processing apparatus 100 calculates the relationship detection error E2 based on the difference between the inference data 155 and the correct answer data 164. As one example, the information processing apparatus 100 calculates a distance for a pair of (number of relationship classes+10)-dimensional vectors for each relationship inference box and sums the distances for the plurality of relationship inference boxes. Note that the error is calculated for object numbers having performed correction based on pairs of inference data and correct answer data for object inference boxes.

The information processing apparatus 100 combines the object detection error E1 and the relationship detection error E2 to calculate the overall error E. As one example, the information processing apparatus 100 calculates a simple sum of the object detection error E1 and the relationship detection error E2 as the overall error E. As another example, the information processing apparatus 100 may calculate a weighted sum of the object detection error E1 and the relationship detection error E2 as the overall error E. The weights of the object detection error E1 and the relationship detection error E2 may be specified as hyperparameters, for example.

However, the information processing apparatus 100 may further add a penalty term to the error function. The penalty term adds a penalty P to the relationship detection error E2. The penalty P is calculated for the inference data for relationship inference boxes.

The information processing apparatus 100 calculates an IoU between two regions included in the inference data of the same relationship inference box. The IoU is the ratio of an area of the logical product of the two regions to an area of the logical sum of the two regions. The minimum value of an IoU is 0, and the maximum value of an IoU is 1. The IoU represents the extent of overlap between the two regions. The smaller the overlap between the two regions, the smaller the IoU, and the larger the overlap between the two regions, the larger the IoU.

The smaller the IoU, the smaller the penalty P, and the larger the IoU, the larger the penalty P. Accordingly, the smaller the overlap of the two regions for which a relationship has been inferred, the smaller the penalty P, and the greater the overlap of the two regions, the larger the penalty P. The larger the penalty P, the higher the overall error. When there is inference data for a plurality of relationship inference boxes, the information processing apparatus 100 may sum the penalties P of the plurality of relationship inference boxes, for example.

However, when the IoU is equal to or less than a threshold value Th, the information processing apparatus 100 regards the penalty P as zero. As one example, P=λ×max (IoU-Th,0) is calculated, where λ is a weighting coefficient. As one example, λ and Th may be specified as hyperparameters.

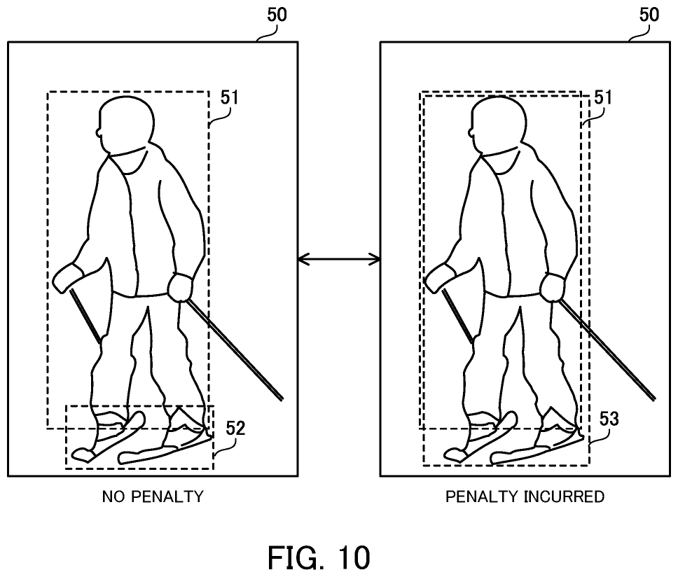

FIG. 10 depicts example relationships between detected regions and the penalty.

The inference model may extract regions 51 and 52 from the image data 50 and infer that a specific relationship is established between the regions 51 and 52. Here, the IoU of the regions 51 and 52 is equal to or less than the threshold value Th. Accordingly, the penalty P is zero. On the other hand, the inference model may extract regions 51 and 53 from the image data 50 and infer that a specific relationship is established between the regions 51 and 53. Here, the IoU of the regions 51 and 53 exceeds the threshold Th. Accordingly, the penalty P is a positive value.

The relationship detection unit 139 infers relationships between the objects using the feature values h provided by the previous stage, not a final object detection result of the object detection unit 138. This means that the relationship detection unit 139 may investigate relationships between various region candidates that are yet to have been sufficiently narrowed down, which creates the risk of inferring relationships between two region candidates that point to what is effectively the same object. For this reason, the information processing apparatus 100 adds a penalty term in keeping with the IoU to the error function. By doing so, inference of a relationship between two regions that have a large extent of overlap is suppressed, which reduces the risk of erroneously inferring a relationship between two regions that point to what is effectively the same object.

Next, the functions and the processing procedure of the information processing apparatus 100 will be described.

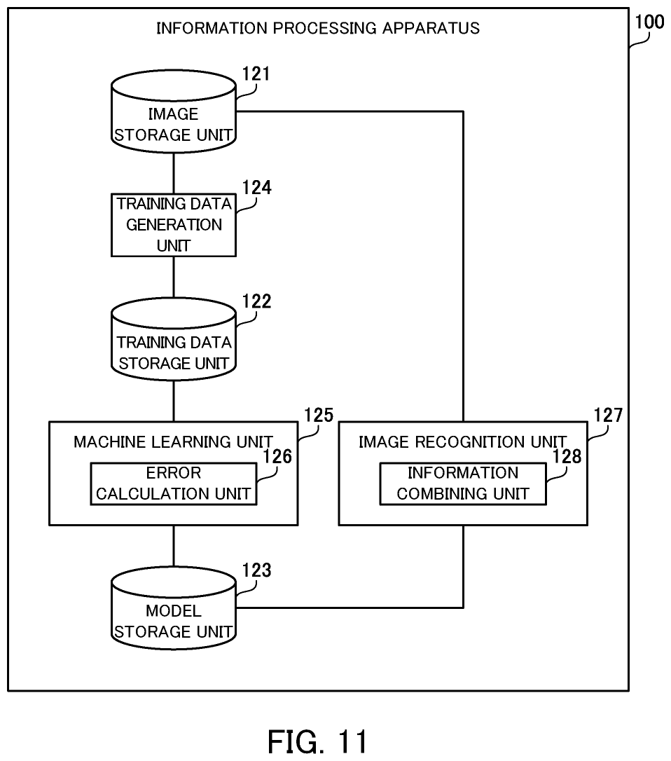

FIG. 11 is a block diagram depicting example functions of the information processing apparatus.

The information processing apparatus 100 includes an image storage unit 121, a training data storage unit 122, and a model storage unit 123. These storage units are implemented using the RAM 102 or the HDD 103, for example. The information processing apparatus 100 also includes a training data generation unit 124, a machine learning unit 125, and an image recognition unit 127. The machine learning unit 125 includes an error calculation unit 126. The image recognition unit 127 includes an information combining unit 128. These processing units are implemented using the CPU 101 and a program, for example.

The image storage unit 121 stores image data. The stored image data includes both image data as training data to be used to generate an inference model and image data that is to be subjected to inference by applying the inference model. The image data for use as training data is provided with annotations with teacher labels. The annotations include object classes, boundary boxes, and relationship classes. The image data to be subjected to inference does not need to be provided with annotations.

The training data storage unit 122 stores training data including a plurality of training data records. A training data record includes input data, which includes image data and a type token, and output data, which includes correct answer data for each object inference box and correct answer data for each relationship inference box. The model storage unit 123 stores the inference model depicted in FIG. 8.

The training data generation unit 124 reads out the annotated image data from the image storage unit 121, generates training data, and stores the training data in the training data storage unit 122. The training data generation unit 124 generates one training data record from each image data. When doing so, the training data generation unit 124 generates correct output data based on the annotations. The training data generation unit 124 also decides the type token based on the number of objects included in the image data and the number of relationships. It is also possible for the training data generation unit 124 to generate a plurality of training data records with different type tokens from the same image data.

The machine learning unit 125 reads training data from the training data storage unit 122, and performs machine learning that optimizes the parameters of the inference model using the training data. The error calculation unit 126 calculates the error between the output of the inference model and the correct answer data included in the training data. When doing so, the error calculation unit 126 calculates the object detection error by comparing the inference data for object inference boxes with the correct answer data for objects and calculates the relationship detection error by comparing the inference data of the relationship inference boxes with the correct answer data for relationships. In addition, the error calculation unit 126 calculates a penalty, which is based on the extent of overlap between the two regions, from the inference data of the relationship inference box, and adds the penalty to the error.

The image recognition unit 127 reads the image data to be subjected to inference from the image storage unit 121 and reads out the inference model from the model storage unit 123. The image recognition unit 127 generates an appropriate type token based on the maximum number of objects to be detected and the maximum number of relationships to be detected. The type token may alternatively be designated by the user. The image recognition unit 127 inputs the image data and the type token into the inference model and generates inference data for a plurality of inference boxes.

The information combining unit 128 combines the inference data of the object inference boxes and the inference data of the relationship inference boxes. By doing so, the information combining unit 128 combines the object detection results and the relationship detection results and associates the object classes of two objects and the relationship class of the relationship between the two objects.

Here, as a general rule, the information combining unit 128 specifies the object inference boxes of two objects to which a relationship class is to be applied based on the object numbers in a relationship inference box. However, when the level of confidence of a relationship class is below a threshold, there is the possibility that the object numbers are incorrect. In this case, the information combining unit 128 compares the region coordinates provided in the relationship inference box with the region coordinates in the respective object inference boxes and searches for object inference boxes with region coordinates that are closest to those given in the relationship inference box. Also, when the difference between the region coordinates of an object inference box indicated by the object numbers and the region coordinates given in a relationship inference box exceeds a threshold, this indicates the possibility that an object number is incorrect. In this case also, the information combining unit 128 searches for an object inference box based on the region coordinates.

The image recognition unit 127 outputs the image recognition result that has been produced by the information combining unit 128. The image recognition result includes the object class of each of the plurality of objects, the boundary box of each of the plurality of objects, and the relationship classes of relationships between the plurality of objects. As one example, the region coordinates of the object inference boxes are used to identify the respective boundary boxes of the plurality of objects. The image recognition unit 127 may display the image recognition result on the display device 111, may store the result in non-volatile storage, and/or may transmit the result to another information processing device.

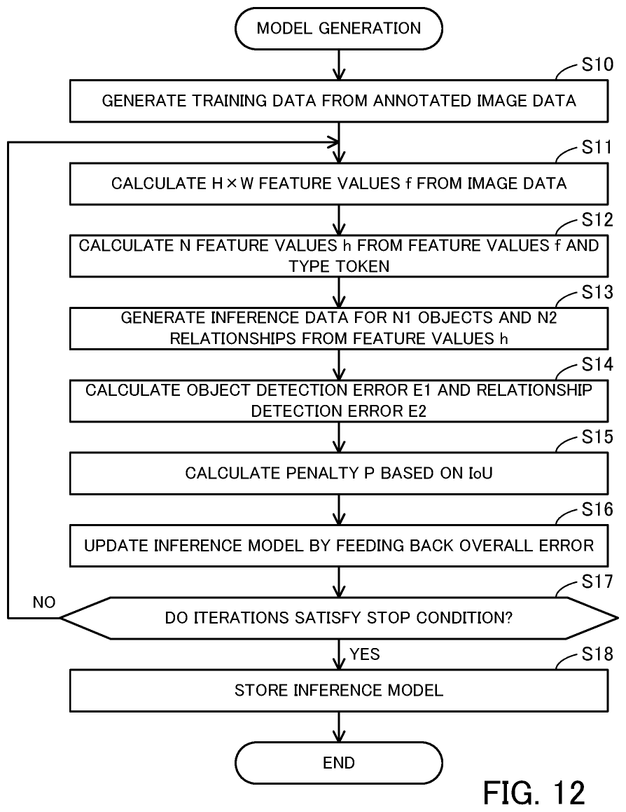

FIG. 12 is a flowchart depicting an example procedure of model generation.

(S10) The training data generation unit 124 reads out the annotated image data. The training data generation unit 124 generates training data from the image data.

(S11) The machine learning unit 125 selects a training data record from the training data. The machine learning unit 125 inputs the image data into the convolutional neural network 131 and generates a feature map whose size is H×W×d. The machine learning unit 125 adds d-dimensional position vectors to the d-dimensional feature values to calculate H×W d-dimensional feature values f.

(S12) The machine learning unit 125 inputs the feature values f into the conversion unit encoder 136 to calculate H×W d-dimensional feature values g. The machine learning unit 125 also inputs the type token into the type encoder 133 to generate N d-dimensional type vectors. The machine learning unit 125 adds the d-dimensional type vectors to d-dimensional query vectors to calculate N d-dimensional queries q. The machine learning unit 125 inputs the queries q and the feature values g into the conversion unit decoder 137 to calculate N feature values h.

(S13) Out of the N feature values h, the machine learning unit 125 inputs N1 feature values h corresponding to object inference boxes one by one into the object detection unit 138 to generate inference data for the object inference boxes. The machine learning unit 125 also inputs N2 feature values h corresponding to the relationship inference boxes one by one into the relationship detection unit 139 to generate inference data for the relationship inference boxes.

(S14) The error calculation unit 126 calculates the object detection error E1 by comparing the inference data for the object inference boxes with the correct answer data. The machine learning unit 125 also calculates the relationship detection error E2 by comparing the inference data for the relationship inference boxes with the correct answer data.

(S15) The error calculation unit 126 calculates the IoU from the two sets of region coordinates included in the inference data of a relationship inference box, and calculates the penalty P based on the IoU. The error calculation unit 126 calculates the overall error from the object detection error E1, the relationship detection error E2, and the penalty P.

(S16) The machine learning unit 125 feeds back the overall error and updates the parameters included in the inference model so that the overall error becomes smaller.

(S17) The machine learning unit 125 determines whether the iterations of steps S11 to S16 satisfy a stop condition. The stop condition may be that the number of iterations has reached a specified number, or that the error has fallen below a threshold value. An upper limit for the number of iterations may be designated by the user. When the stop condition is satisfied, the processing proceeds to step S18. When the stop condition is not satisfied, the processing returns to step S11.

(S18) The machine learning unit 125 stores the inference model in the model storage unit 123.

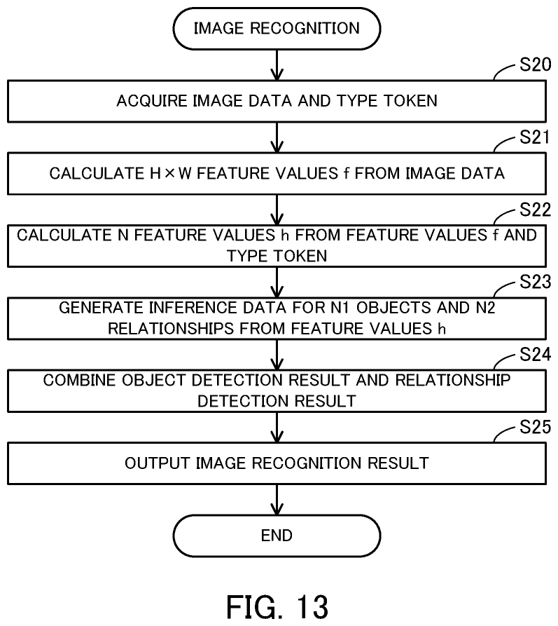

FIG. 13 is a flowchart depicting an example procedure of image recognition.

(S20) The image recognition unit 127 acquires image data to be subjected to inference and a type token. The type token may be designated by the user.

(S21) The image recognition unit 127 inputs the image data into the convolutional neural network 131 to generate a feature map whose size is H×W×d. The image recognition unit 127 adds position vectors to the d-dimensional feature values to calculate H×W feature values f.

(S22) The image recognition unit 127 inputs the feature values f into the conversion unit encoder 136 to calculate H×W feature values g. The image recognition unit 127 also inputs the type token into the type encoder 133 to generate N type vectors. The image recognition unit 127 adds the type vectors to query vectors to calculate N queries q. The machine learning unit 125 inputs the queries q and the feature values g into the conversion unit decoder 137 to calculate N feature values h.

(S23) Out of the N feature values h, the image recognition unit 127 inputs N1 feature values h corresponding to object inference boxes one by one into the object detection unit 138 to generate inference data for the object inference boxes. The image recognition unit 127 also inputs N2 feature values h corresponding to the relationship inference boxes one by one into the relationship detection unit 139 to generate inference data for the relationship inference boxes.

(S24) The information combining unit 128 combines the object detection result and the relationship detection result, and associates the object classes of a plurality of objects, the regions of the plurality of objects, and the relationship classes of relationships between the objects. This associating is performed based on the object numbers and the region coordinates included in the inference data.

(S25) The image recognition unit 127 outputs the image recognition result. The image recognition result includes the object classes of a plurality of objects, the boundary boxes of the plurality of objects, and the relationship classes of relationships between the objects. The image recognition unit 127 may display the image recognition result on the display apparatus 111, may store the result in non-volatile storage, and/or may transmit the result to another information processing device. Note that the information processing apparatus 100 may generate a scene graph based on the image recognition result, and may execute an application, such as VQA or image searching, using the generated scene graph.

As described above, the information processing apparatus 100 according to the second embodiment generates an inference model, which performs both object detection and relationship detection, through machine learning. The information processing apparatus 100 uses the generated inference model to detect a plurality of objects and relationships between the objects from the image data. By doing so, it is possible to automatically generate a scene graph. The accuracy of the scene graph is improved, which in turn raises the accuracy of applications such as VQA and image searching.

The conversion unit (or “transformer”) included in the inference model is shared by the object detection unit and the relationship detection unit. The parameters of the conversion unit are optimized so that the conversion unit may generate both information that is useful for object detection and information that is useful for relationship detection. By doing so, information obtained during object detection is used during relationship detection and information obtained during relationship detection is used during object detection, which improves the accuracy of both the object detection and the relationship detection. In particular, compared to a configuration where a relationship detection task is performed after an object detection task, it is possible for an inference model to infer object classes that match the inference result for relationship classes, which improves the accuracy of object detection.

The information processing apparatus 100 designates whether each inference box is to output an object detection result or to output a relationship detection result according to a type token. The conversion unit included in the inference model calculates different feature values for each inference box according to the type token. By doing so, it is possible for the inference model to output inference data in formats that differ between object detection and relationship detection.

The information processing apparatus 100 also adds a penalty term, which indicates a penalty in keeping with the extent of overlap between two regions for which a relationship has been inferred, to the error function used in machine learning. By doing so, the information processing apparatus 100 is able to reduce the risk of the inference model inferring a relationship between two region candidates that represent effectively the same object. The information processing apparatus 100 also combines the object detection result and the relationship detection result based on object numbers and region coordinates. By doing so, a highly accurate image recognition result is outputted.

According to one aspect, the present embodiments improve the accuracy of information extracted from image data.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
acquiring training data in which first image data, object information indicating a plurality of first objects included in the first image data, and relationship information indicating a first relationship between the plurality of first objects are associated; and
executing machine learning that trains, based on the training data, an inference model that infers both a plurality of second objects included in second image data and a second relationship between the plurality of second objects or selectively infers one of the plurality of second objects and the second relationship according to an input of the second image data to the inference model, the machine learning using a penalty term when calculating an error between an inference result of the inference model and the training data, the penalty term causing the error to increase as an overlap between a plurality of inferred image regions, which are inferred to be image regions in which objects are present in the inference result, increases.

2. The non-transitory computer-readable recording medium according to claim 1,
wherein the inference model includes:
a first block that calculates feature values of the second image data;
a second block that infers the plurality of second objects using the feature values; and
a third block that infers the second relationship using the feature values.

3. The non-transitory computer-readable recording medium according to claim 2,
wherein the first block calculates the feature values from the second image data and type selection information indicating whether to infer the plurality of second objects or to infer the second relationship,
the feature values are inputted into the second block when the plurality of second objects are to be inferred, and
the feature values are inputted into the third block when the second relationship is to be inferred.

4. The non-transitory computer-readable recording medium according to claim 1,
wherein the inference model outputs a plurality of inference boxes, and
the plurality of inference boxes selectively include one of an inference result for one second object out of the plurality of second objects and an inference result for the second relationship, based on type selection information inputted into the inference model.

5. The non-transitory computer-readable recording medium according to claim 1,
wherein the inference model infers image regions in which the plurality of second objects are present in the second image data, object classes indicating respective types of the plurality of second objects, and a relationship class indicating a type of the second relationship.

6. A method of generating an inference model comprising:
acquiring, by a processor, training data in which first image data, object information indicating a plurality of first objects included in the first image data, and relationship information indicating a first relationship between the plurality of first objects are associated; and
executing, by the processor, machine learning that trains, based on the training data, an inference model that infers both a plurality of second objects included in second image data and a second relationship between the plurality of second objects or selectively infers one of the plurality of second objects and the second relationship according to an input of the second image data to the inference model, the machine learning using a penalty term when calculating an error between an inference result of the inference model and the training data, the penalty term causing the error to increase as an overlap between a plurality of inferred image regions, which are inferred to be image regions in which objects are present in the inference result, increases.

7. An information processing apparatus comprising:
a memory that stores training data in which first image data, object information indicating a plurality of first objects included in the first image data, and relationship information indicating a first relationship between the plurality of first objects are associated; and
a processor that executes machine learning which trains, based on the training data, an inference model that infers both a plurality of second objects included in second image data and a second relationship between the plurality of second objects or selectively infers one of the plurality of second objects and the second relationship according to an input of the second image data to the inference model, the machine learning using a penalty term when calculating an error between an inference result of the inference model and the training data, the penalty term causing the error to increase as an overlap between a plurality of inferred image regions, which are inferred to be image regions in which objects are present in the inference result, increases.
